(19) United States
(12) Patent Application Publication
(10) Pub. No.: US 2002/0038796 A1
(43) Pub. Date: Apr. 4, 2002

(54) Dual purpose welding clamp

(76) Inventor: Raymond Leon JR., Indio, CA (US)

Correspondence Address: Timothy T. Tyson, Freilich, Hornbaker & Rosen, Suite 1220, 10960 Wilshire Blvd., Los Angeles, CA, 90024, US

(21) Appl. No.: 09/969,932

(22) Filed: Oct. 3, 2001

Related U.S. Application Data
(60) Provisional application No. 60/237,134, filed on Oct. 3, 2000.

(51) Int. Cl. B23K 9/00; B25B 11/00

(52) U.S. Cl. 219/136; 269/8

(57) ABSTRACT

A dual purpose welding clamp (20) includes a spring clamp (22) having upper and lower jaws. An upper conductor (30) is connected to the upper jaw, and a lower conductor (32) is connected to the lower jaw. The upper (30) and lower (32) conductors may be clamped about an object (502) to be welded. Alternatively, a magnet (26) and magnet housing (24) may be magnetically connected to a magnetic object (500) to be welded. A spring loaded terminal (38), which abuts the magnetic object (500) being welded is connected to lower conductor (32). In a second embodiment of welding clamp (120), spring loaded terminal (138) is disposed in a hole (125) in magnet (126).

### CROSS REFERENCE TO RELATED APPLICATION

This application claims the filing benefit under 35 U.S.C. §119(e) of U.S. Provisional Application No. 60/237,134, filed Oct. 3, 2000, which is included herein by reference.

### TECHNICAL FIELD

The present invention pertains generally to welding, and in particular to a welding clamp which is attached to objects to provide a ground during arc welding. The clamp is dual purpose, having jaws that can be attached to an object, and also having a flat magnet that can be attached to magnetic objects.

### BACKGROUND ART

When arc welding, it is necessary to attach a ground to the object being welded while the other pole of the electric circuit is the welding rod. When the electricity passes through the welding rod to the object, it melts the tip of the welding rod thereby depositing molten metal on the object.

Usually a spring clamp is used to connect the ground cable from the welding apparatus to the object. Nuts on the top of the clamps are used to attach the lug of the ground cable to the clamps. In another common embodiment, a spring loaded terminal is attached to a flat magnetic clamp. The spring loaded terminal has a bolt that passes through the middle of the magnet and abuts the object to be welded. In this fashion, the electric current does not pass through the magnet, but rather is shunted directly through the bolt.

### DISCLOSURE OF INVENTION

The present invention is directed to a dual purpose welding clamp that can be attached to an object with jaws, or alternatively can be attached to a magnetic object with an integral magnet. By providing two methods of attachment, the present invention avoids the inconvenience and expense of having to stock and use two different types of welding clamps. Additionally, the present invention provides an alternative method of attachment when the jaws of the clamp cannot open wide enough to accept the object. Disclosed herein are two embodiments of the present invention.

In accordance with a preferred embodiment, the welding clamp includes a spring clamp having upper and lower jaws, an upper conducted connected to said upper jaw, a lower conductor connected to said lower jaw, the lower conductor including a spring loaded terminal, and, a magnet connected to the lower jaw of said spring clamp.

In accordance with an important feature, the welding clamp further includes a stop mechanism for preventing the jaws of the spring clamp from fully closing.

In accordance with another important feature, the welding clamp further includes the magnet disposed within a magnet housing and the magnet housing connected to the lower jaw of the spring clamp.

In accordance with another important feature, the welding clamp further includes the magnet insulated from both the spring clamp and the magnet housing.

In accordance with yet another feature, the welding clamp further includes a protective cover for preventing debris from contacting the magnet.

In accordance with a second preferred embodiment, the welding clamp includes a spring clamp having upper and lower jaws, an upper conductor connected to the upper jaw, a lower conductor connected to the lower jaw, a lower conductor including a spring loaded terminal, and, a magnet connected to the lower jaw of the spring clamp.

In accordance with an important feature of the second embodiment, the welding clamp further includes the magnet disposed within a magnet housing, and, the magnet housing connected to the lower jaw of the spring clamp.

In accordance with another important feature of the second embodiment, the welding clamp further includes the magnet insulated from both the spring clamp and the magnet housing.

In accordance with yet another important feature of the second embodiment, the welding clamp further includes a protective cover for preventing debris from contacting the magnet.

In accordance with yet another important feature of the second embodiment, the welding clamp further includes the magnet having a hole, and, the spring loaded terminal disposed in the hole.

Other features and advantages of the present invention will become apparent from the following detailed description, taken in conjunction with the accompanying drawings, which illustrate, by way of example, the principles of the invention.

### BRIEF DESCRIPTION OF DRAWINGS

FIG. 1 is a side elevation view of a dual purpose welding clamp in accordance with the present invention;

FIG. 2 is a bottom perspective view of the welding clamp with a protective cover removed;

FIG. 3 is a bottom perspective view of the welding clamp with the protective cover installed;

FIG. 4 is a side elevation view of the welding clamp installed on a flat magnetic object;

FIG. 5 is a perspective view of the welding clamp installed on a flat magnetic object;

FIG. 6 is a side elevation view of the welding clamp installed about a metal pipe;

FIG. 7 is a perspective view of the welding clamp installed about a metal pipe;

FIG. 8 is a side elevation view of a second embodiment of the dual purpose welding clamp in accordance with the present invention;

FIG. 9 is a top perspective view of the welding clamp;

FIG. 10 is a bottom perspective view of the welding clamp with the protective cover removed;

FIG. 11 is a side elevation view of the welding clamp installed on a flat magnetic object;

FIG. 12 is a side elevation view of the welding clamp installed about a metal pipe, and,

FIG. 13 is a perspective view of welding clamp installed about a square metal member.

### MODES FOR CARRYING OUT THE INVENTION

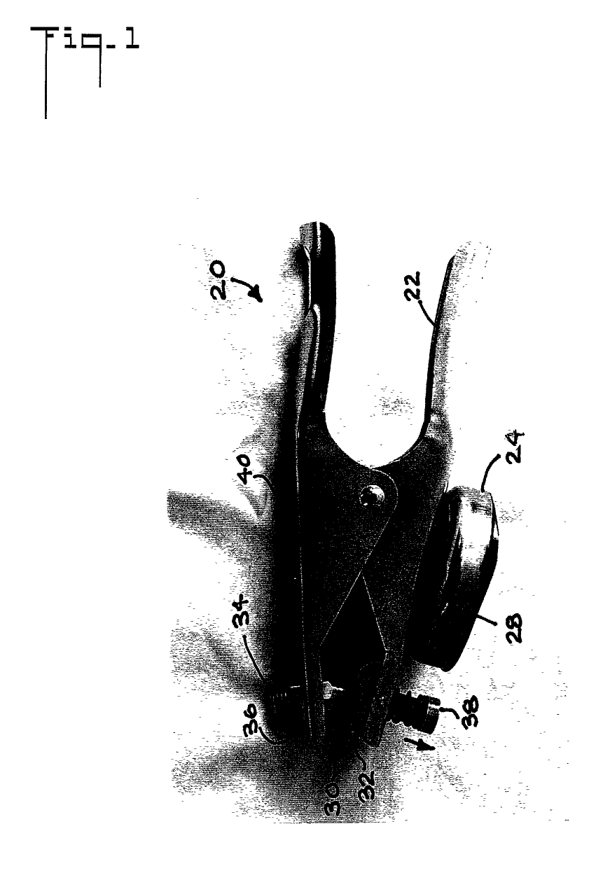

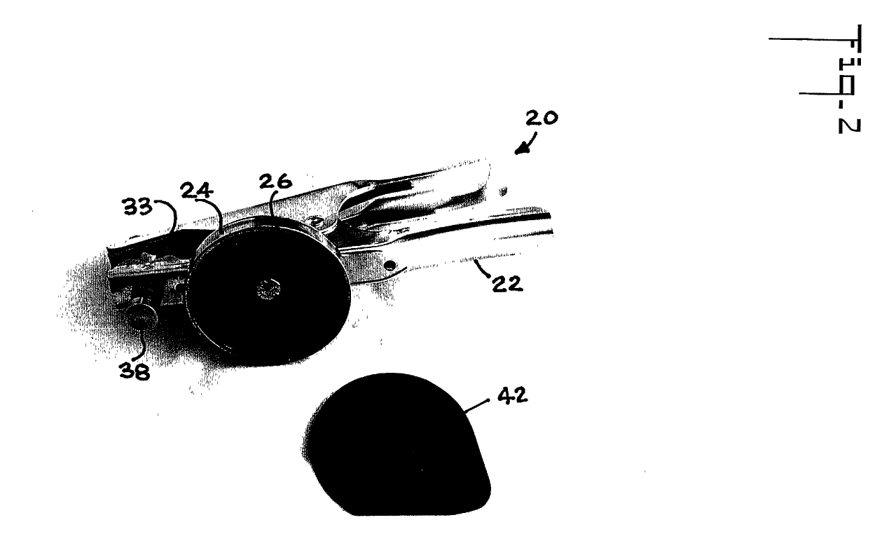

Referring initially to FIG. 1, there is illustrated a side elevation view of a dual purpose welding clamp in accordance with the present invention, generally designated as 20. A preferred name for this embodiment is GROUND-ALL. Welding clamp 20 includes a spring clamp 22 having upper and lower jaws. A circular magnet housing 24 and circular magnet 26 is connected to the lower jaw of spring clamp 22 using a bolt 40. Circular magnet 26 having a central hole is enclosed within magnet housing 24 (also refer to FIG. 2). A non-conductive bushing/washer arrangement 28 is used to connect magnet housing 24 to spring clamp 22 so that magnet housing 24 is electrically insulated from spring clamp 22. Similarly, an electrical insulator (not shown) is placed between magnet 26 and magnetic housing 24, so that magnet 26 is also insulated from magnetic housing 24. This is so that current does not flow through magnet 26 and thereby reduce its magnetism. In a preferred embodiment, magnet 26 is glued into magnet housing 24.

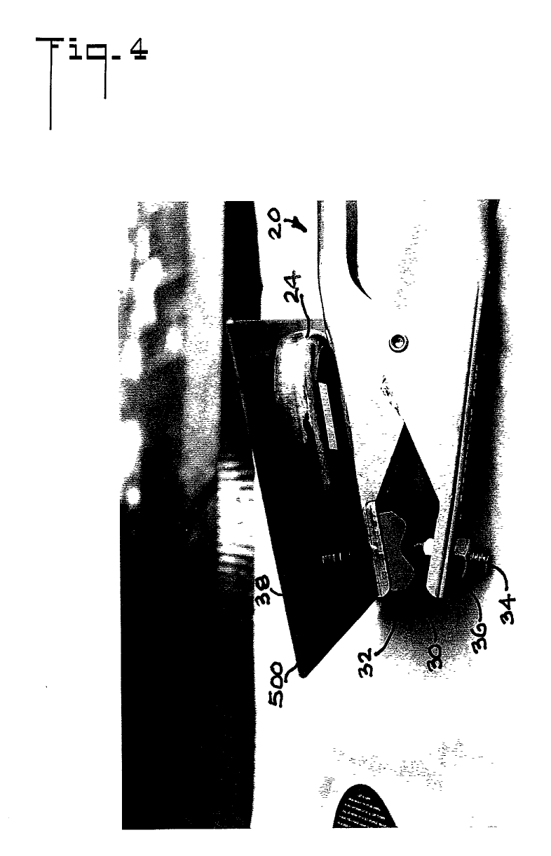

Welding clamp 20 also includes upper 30 and lower 32 conductors connected to its upper and lower jaws respectively. A conductive copper cable 33 (refer to FIG. 2) is connected between the upper 30 and lower 32 conductors. Upper conductor 30 includes a threaded post 34 and nut 36 to accept the lug of a welding cable (not shown). Lower conductor 32 includes a spring loaded terminal 38 which is spring biased away from the lower jaw of spring clamp 22. When welding clamp 20 is placed upon a magnet object 500, magnet 26 and magnet housing 24 reside on the same plane as spring loaded terminal 38, with the electric current passing though spring loaded terminal 38 (refer to FIG. 4). During welding, the electric current flows from upper conductor 30, through cable 33, to lower conductor 32. Lower conductor 32 is not rigidly connected to the lower jaw of spring clamp 22, but rather is free to float up and down. An internal stop mechanism comprising internally mounted bolt 40 (the same bolt that connects magnet housing 24 to spring clamp 22) prevents the jaws of spring clamp 22 from fully closing. That is, there is always a gap between upper conductor 30 and lower conductor 32. If stop mechanism 40 were not provided, upper conductor 30 would exert force upon lower conductor 32 and push spring loaded terminal 38 too far below the plane of magnet 26 and magnet housing 24, thereby interfering with attachment to a flat magnetic object 500.

FIG. 2 is a bottom perspective view of welding clamp 20. Magnet 26 is disposed within magnet housing 24. A protective cover 42 has been removed from magnet 26.

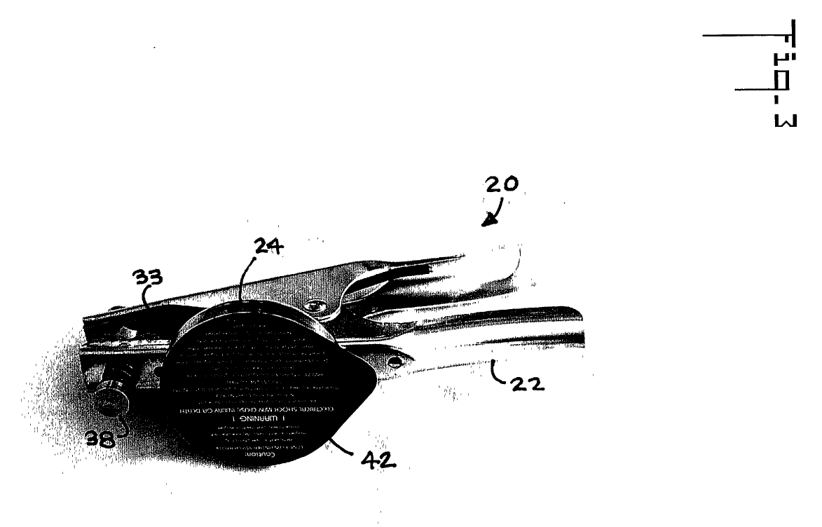

FIG. 3 is a bottom perspective view of the welding clamp 20 with protective cover 42 installed. When not in use, protective cover 42 prevents magnetic metal shavings and debris from contacting magnet 26, or from becoming lodged in spaces between magnet 26 and magnet housing 24.

FIG. 4 is a side view of welding clamp 20 installed on a flat magnetic object 500. Magnet housing 24, magnet 26, and spring loaded terminal 38 all abut object 500.

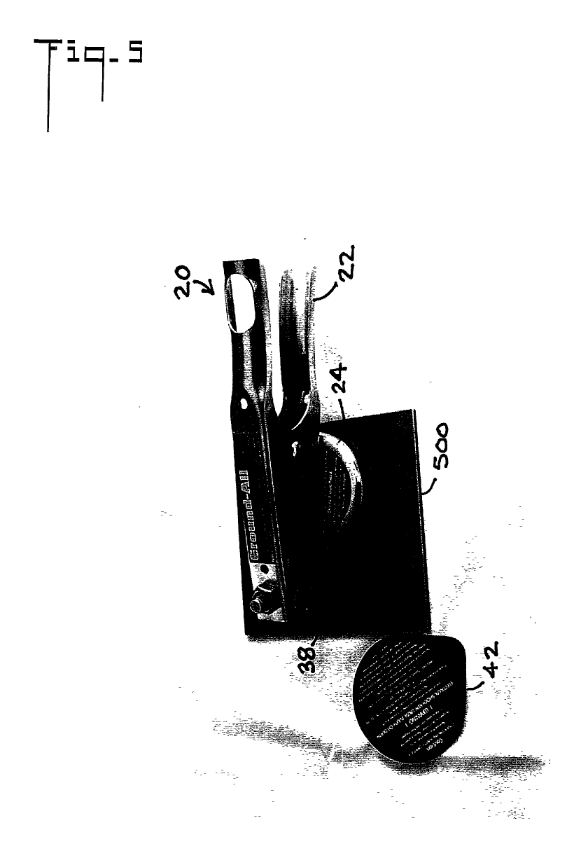

FIG. 5 is a perspective view of welding clamp 20 installed on a flat magnetic object 500;

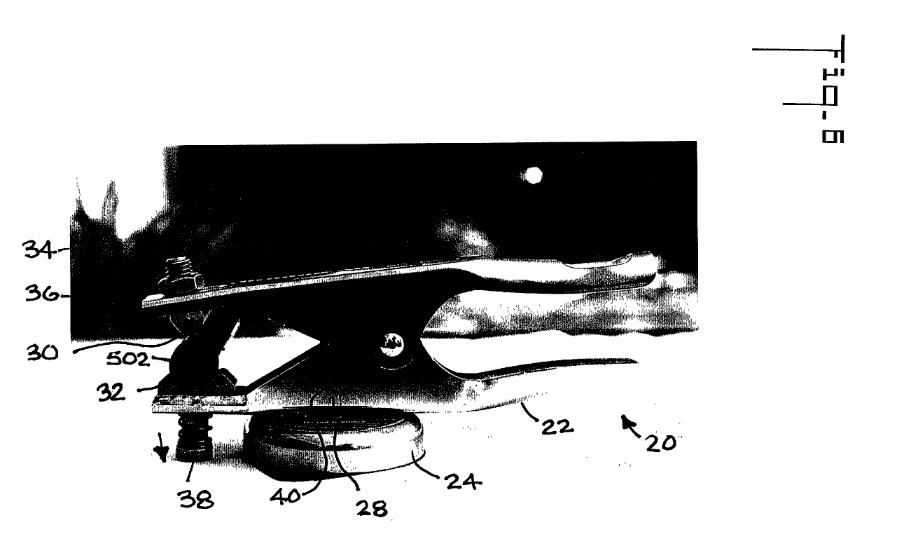

FIG. 6 is a side elevation view of welding clamp 20 installed about a metal pipe 502. Upper 30 and lower 32 conductors abut metal pipe 502; and,

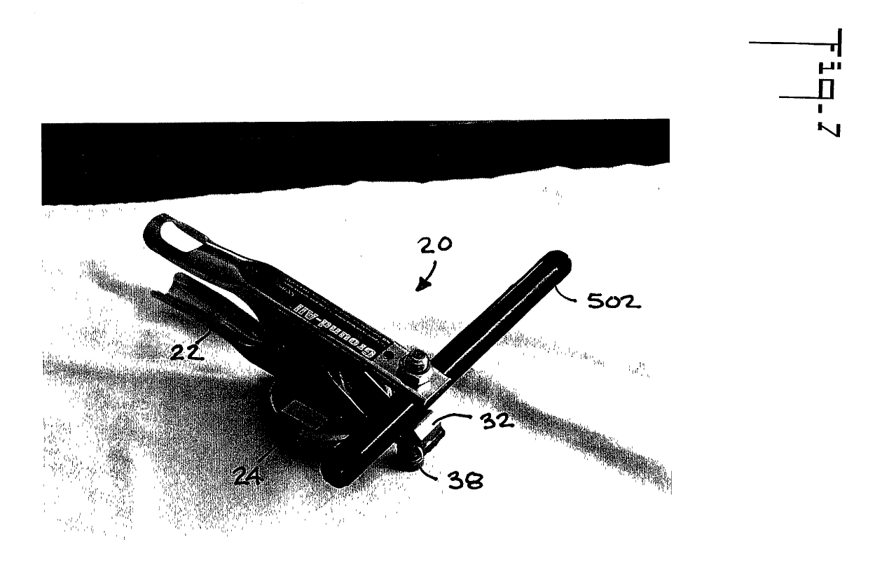

FIG. 7 is a perspective view of welding clamp 20 installed about a metal pipe 502.

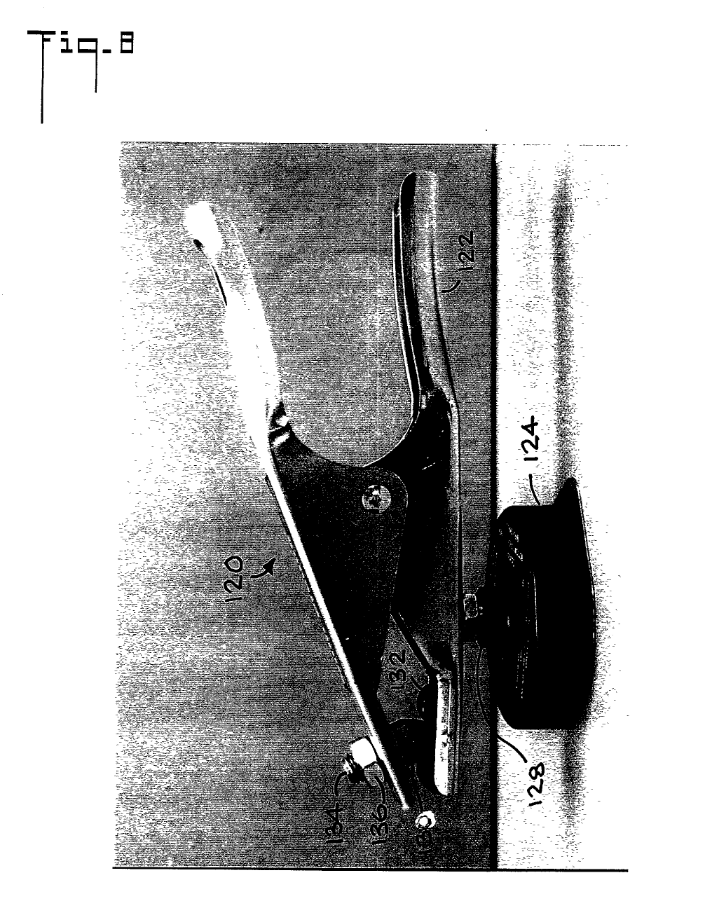

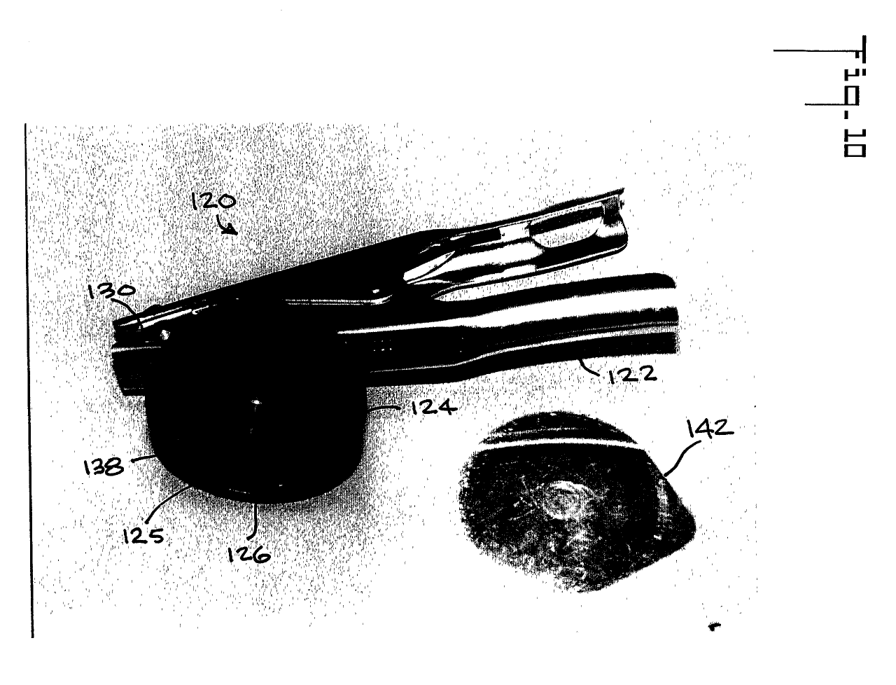

FIG. 8 is a side elevation view of a second embodiment of the dual purpose welding clamp in accordance with the present invention, generally designated as 120. The preferred name for this embodiment is MULTI-GROUND. Welding clamp 120 is similar to welding clamp 20, and includes a spring clamp 122 having upper and lower jaws. The principal difference between welding clamp 120 and welding clamp 20 is that in welding clamp 120 the spring loaded terminal 138 resides in a hole 125 in magnet 126 (refer also to FIG. 10), rather than being located near the end of the lower jaw. A circular magnet housing 124 and circular magnet 126 is connected to the lower jaw of spring clamp 122. Circular magnet 126 has a central hole 125 and is enclosed within magnet housing 124. A non-conductive bushing/washer arrangement 128 is used to connect magnet housing 124 to spring clamp 122 so that magnet housing 124 is electrically insulated from spring clamp 122, Similarly, an electrical insulator (not shown) is placed between magnet 126 and magnetic housing 124, so that magnet 126 is also insulated from magnetic housing 124. This is so that current does not flow through magnet 126 and thereby reduce its magnetism. In a prefer red embodiment, magnet 126 is glued into magnet housing 124.

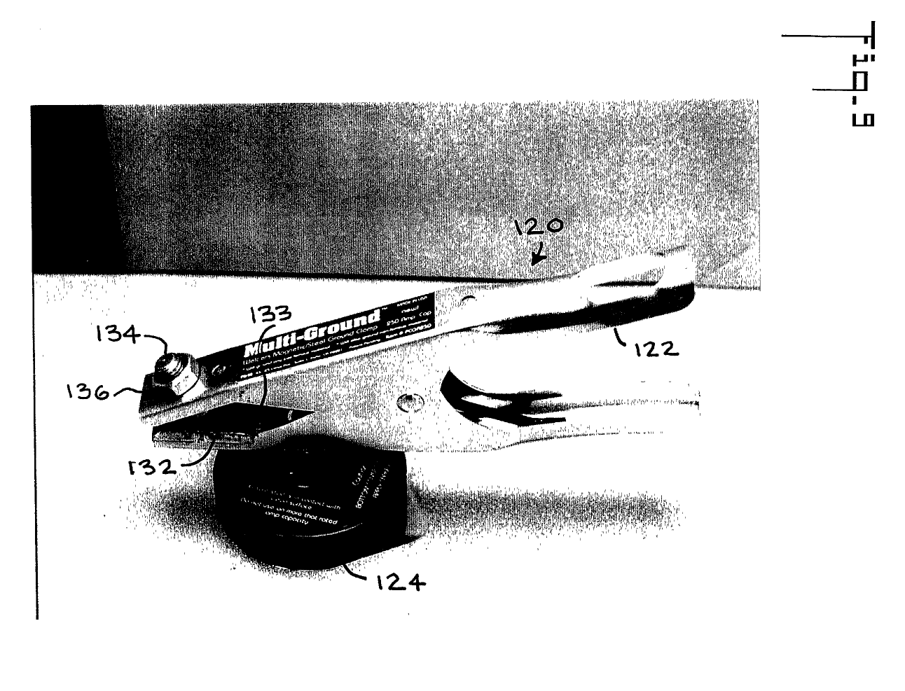

Welding clamp 120 also includes upper 130 and lower 132 conductors connected to its upper and lower jaws respectively. A conductive copper cable 133 (refer to FIG. 9) is connected between the upper 130 and lower 132 conductors, and to spring loaded terminal 138. Upper conductor 130 includes a threaded post 134 and nut 136 to accept the lug of a welding cable (not shown). Lower conductor 132 is connected to a spring loaded terminal 138 (refer also to FIG. 10) which is disposed in central hole 125 in magnet 126. Spring loaded terminal 138 is spring biased away from the bottom of magnet 126. When welding clamp 120 is placed upon a magnetic object 500, magnet 126 and magnet housing 124 reside on the same plane as spring loaded terminal 138, with the electric current passing though spring loaded terminal 138. During welding, the electric current flows from upper conductor 130, through cable 133, and thence to either lower conductor 132 or spring loaded terminal 138, depending upon whether magnet 126 or the upper and lower jaws are utilized to attach welding clamp 120 to a magnetic object.

FIG. 9 is a top perspective view of welding clamp 120.

FIG. 10 is a bottom perspective view of welding clamp 120 with the protective cover 142 removed. Spring loaded terminal 13 8 is disposed in central hole 125 of magnet 126.

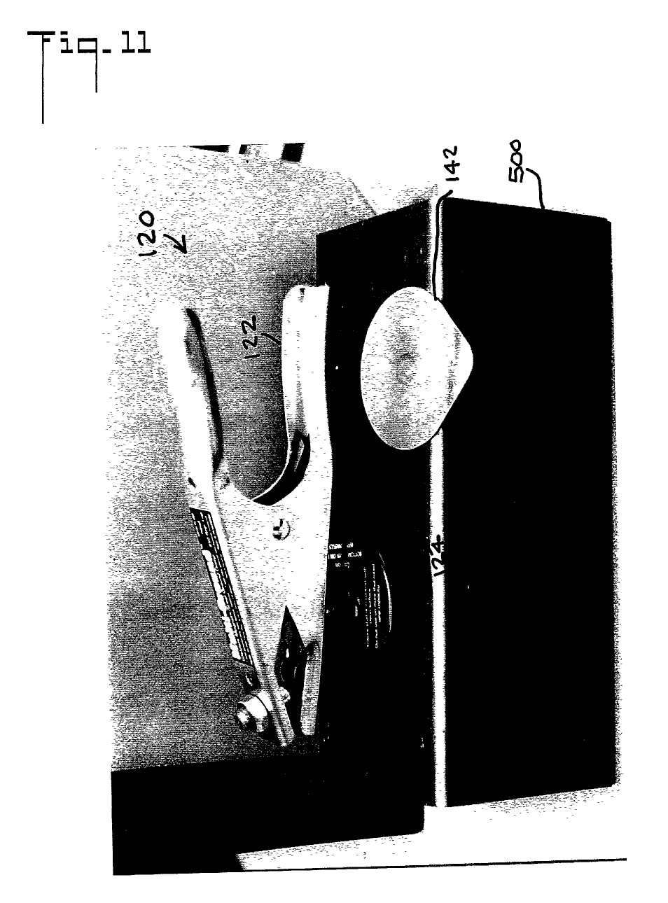

FIG. 11 is a side elevation view of welding clamp 120 installed on a flat magnetic object 500. Spring loaded terminal 138 abuts object 500.

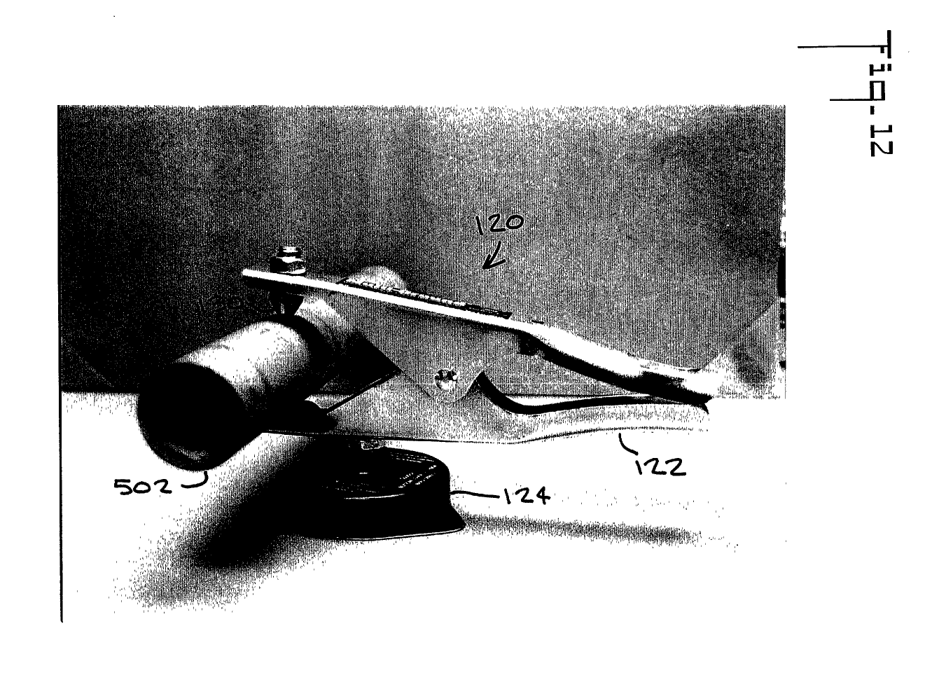

FIG. 12 is a side elevation view of welding clamp 120 installed about a metal pipe 502.

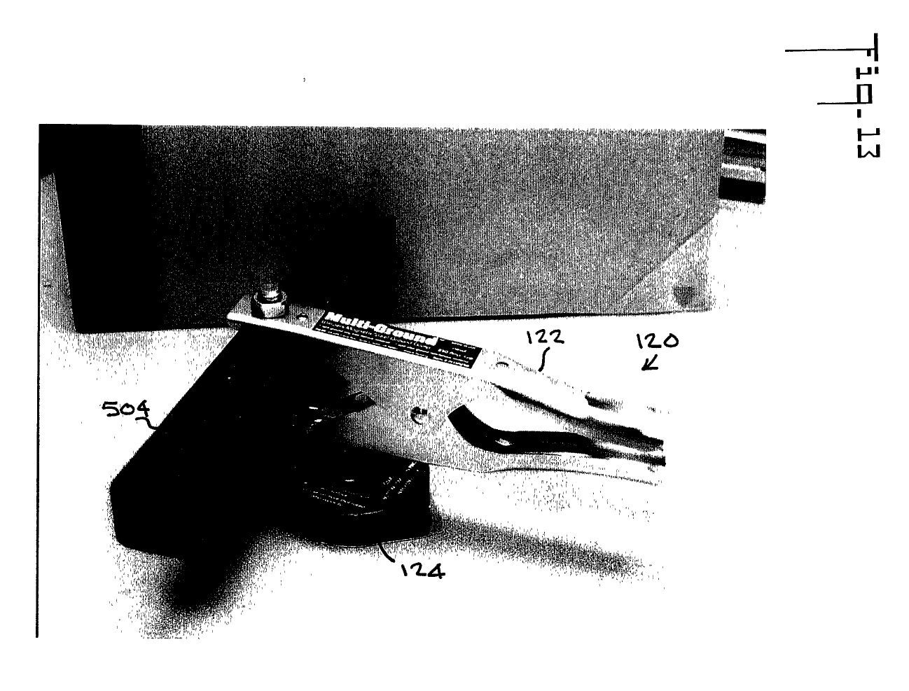

FIG. 13 is a perspective view of welding clamp 120 installed about a square metal member 504.

Other features and advantages of the present invention will become apparent from the accompanying drawings, which illustrate, by way of example, the principles of the invention. The preferred embodiments of the invention described herein are exemplary and numerous modifications, dimensional variations, and rearrangements can be readily envisioned to achieve an equivalent result, all of which are intended to be embraced within the scope of the appended claims.

I claim:

1. A welding clamp, comprising:
a spring clamp having upper and lower jaws;
an upper conducted connected to said upper jaw;
a lower conductor connected to said lower jaw;
said lower conductor including a spring loaded terminal; and,
a magnet connected to said lower jaw of said spring clamp.

2. A welding clamp according to claim 1, further including:
a stop mechanism for preventing the jaws of the spring clamp from fully closing.

3. A welding clamp according to claim 1, further including:
said magnet disposed within a magnet housing; and,
said magnet housing connected to said lower jaw of said spring clamp.

4. A welding clamp according to claim 3, further including:
said magnet insulated from both said spring clamp and said magnet housing.

5. A welding clamp according to claim 3, further including:
a protective cover for preventing debris from contacting said magnet.

6. A welding clamp, comprising:
a spring clamp having upper and lower jaws;
an upper conducted connected to said upper jaw;
a lower conductor connected to said lower jaw;
said lower conductor including a spring loaded terminal; and,
a magnet connected to said lower jaw of said spring clamp.

7. A welding clamp according to claim 6, further including:
said magnet disposed within a magnet housing; and,
said magnet housing connected to said lower jaw of said spring clamp.

8. A welding clamp according to claim 7, further including:
said magnet insulated from both said spring clamp and said magnet housing.

9. A welding clamp according to claim 7, further including:
a protective cover for preventing debris from contacting said magnet.

10. A welding clamp according to claim 6, further including:
said magnet having a hole; and,
said spring loaded terminal disposed in said hole.
